(19) United States
(12) Patent Application Publication
(10) Pub. No.: US 2007/0143424 A1
(43) Pub. Date: Jun. 21, 2007

(54) Distribution list for a reply message

(75) Inventors: Andrew L. Schirmer, Andover, MA (US); Michael Muller, Medford, MA (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 11/314,216

(22) Filed: Dec. 21, 2005

(51) Int. Cl. G06F 15/16

(52) U.S. Cl. 709/206

(57) ABSTRACT

Embodiments of the present invention address deficiencies of the art in respect to electronic messaging and provide a method, system and computer program product for distribution list management for a reply electronic message. In one embodiment of the invention, a distribution list management method for a reply message in a message thread can include identifying a set of addressees from among multiple messages in a message thread and adding the set of addresses to a distribution list for a reply message to one of the multiple messages in the message thread. Individual ones of the addressees in the distribution list can be selected to receive the reply message. Subsequently, the reply message can be sent to the selected individual ones of the addressees.

### BACKGROUND OF THE INVENTION

1. Field of the Invention

The present invention relates to electronic messaging and more particularly to distribution list management for an electronic message.

2. Description of the Related Art

Electronic messaging represents the single most useful task accomplished over wide-scale computer communications networks. Some argue that in the absence of electronic messaging, the Internet would have amounted to little more than a science experiment. Today, electronic messaging seems to have replaced the ubiquitous telephone and fax machine for the most routine of interpersonal communications. As such, a variety of electronic messaging systems have arisen which range from real-time instant messaging systems and wireless text pagers to asynchronous electronic mail systems.

Electronic mail, a form of electronic messaging referred to in the art as e-mail, has proven to be the most widely used computing application globally. Though e-mail has been a commercial staple for several decades, due to the explosive popularity and global connectivity of the Internet, e-mail has become the preferred mode of communications, regardless of the geographic separation of communicating parties. Today, more e-mails are processed in a single hour than phone calls. Clearly, e-mail as a mode of communications has been postured to replace all other modes of communications, save for voice telephony.

Modern electronic messaging clients provide a “reply” function which permits the composition of a message by a composer in reply to a message received by the composer. By selecting the reply option, a new message window can open addressed to the sender of the received message. Notably, where the received message had been addressed to multiple recipients in addition to the composer, a “reply-all” function permits the addressing of a reply message to all recipients designated by the original received message. Thus, the reply-all operation can be an efficient mechanism where all addresses of a received message are intended to receive a reply from the composer.

In many cases, it is not desirable to address a reply-all message to all recipients of a received message. In this circumstance, the composer can select the reply function and manually provide the additional addresses, or the composer can select the reply-all function and manually can remove undesirable addresses. Depending upon the distribution list for a reply message, pruning the distribution list can be mouse-click intensive and prone to errors such as the duplicate addressing of the reply message to the same person. Accidentally transmitting a reply message to a recipient multiple times can be an irritant to the recipient.

Notably, the reply-all function only processes the addressees for the subject electronic message. In a chain of messages, referred to in the art as a “thread”, addressees for messages embedded within the thread, but not present in the most recent message can be excluded from a “reply-all” message. Yet, it can be in the intent of the reply message composer to include addressees from other messages in the thread. In this circumstance, as before, the composer must manually add each desired addressee.

### BRIEF SUMMARY OF THE INVENTION

Embodiments of the present invention address deficiencies of the art in respect to electronic messaging and provide a novel and non-obvious method, system and computer program product for distribution list management for a reply electronic message. In one embodiment of the invention, a distribution list management method for a reply message in a message thread can include identifying a set of addressees from among multiple messages in a message thread and adding the set of addresses to a distribution list for a reply message to one of the multiple messages in the message thread. Individual ones of the addressees in the distribution list can be selected to receive the reply message. Subsequently, the reply message can be sent to the selected individual ones of the addressees.

In one aspect of the invention, selecting individual ones of the addressees in the distribution list to receive the reply message can include rendering a graphical user interface (GUI) displaying the distribution list and assigning at least one message recipient role to at least one of the addressees in the distribution list in the GUI. In another aspect of the invention, the method further can include further assigning an attachment for transmission to at least one of the addressees in the distribution list in the GUI. In yet another aspect of the invention, the method further can include assigning a priority for the reply message to at least one of the addressees in the distribution list in the GUI.

In another embodiment of the invention, a data processing system for distribution list management for a reply message can include a messaging client configured to process a message thread of multiple related messages, each of the messages comprising at least one addressee, and an addressee master list configured to store a distribution list of addressees for all of the multiple related messages in the message thread. Importantly, message reply logic can be provided which can include program code enabled to render a distribution list management user interface through which individual addressees in the addressee master list are selected to receive a reply message to a message in the message thread.

In one aspect of the embodiment, the program code for the message reply logic can be further enabled to assign a message recipient role to selected ones of the addressees in the addressee master list. In another aspect of the embodiment, the program code for the message reply logic can be further enabled to assign at least one attachment for the reply message to selected ones of the addressees in the addressee master list. In yet another aspect of the embodiment, the program code for the message reply logic can be yet further enabled to assign a priority for the reply message to selected ones of the addressees in the addressee master list.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a data processing system configured for distribution list management for a reply message;

FIG. 2 is a screen shot of a graphical user interface configured for distribution list management for a reply message; and,

FIG. 3 is a flow chart illustrating a process for distribution list management for a reply message.

### DETAILED DESCRIPTION OF THE INVENTION

Embodiments of the present invention provide a method, system and computer program product for managing a distribution list for a reply to a electronic message. In accordance with an embodiment of the present invention, a message in a message thread can be selected for reply. The addressees for each message in the thread can be retrieved and presented in a user interface for inclusion in a distribution list for the reply message. Other addressees can be manually specified within the user interface for inclusion in the distribution list. Optionally, an attachment to the reply message can be sent to only selected addressees for the reply message. In this way, the composer of the reply message can designate addressees for the reply message not only included in the immediate predecessor message in the thread, but also those addressees included in other predecessor messages in the thread.

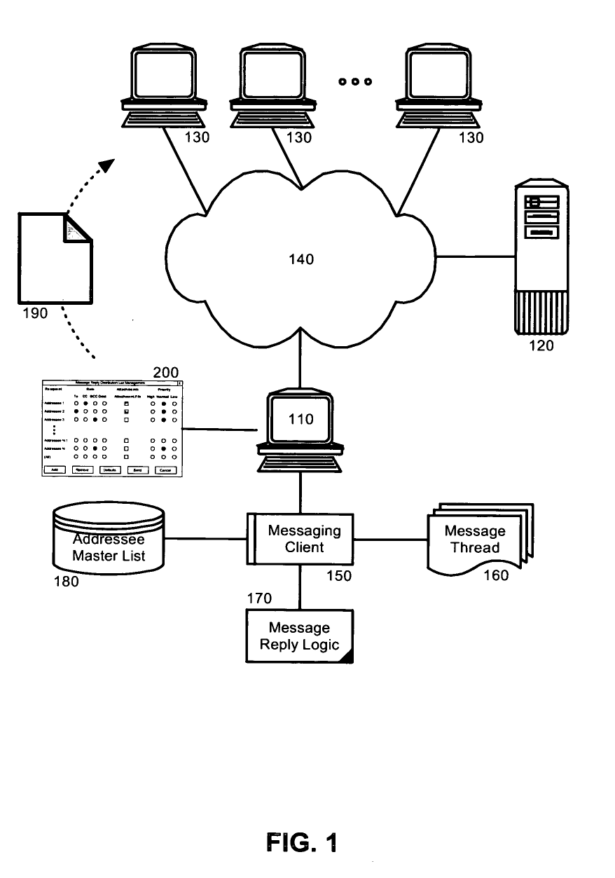

In further illustration, FIG. 1 is a schematic illustration of a data processing system configured for distribution list management for a reply message. As shown in FIG. 1, the data processing system can include a computing platform 110 configured for communicative coupling to other computing platforms 130 over a computer communications network 140. The computing platform 110 can include a messaging client 150 which optionally can be enabled to communicate with a messaging server 120 over the computer communications network 140 in order to exchange electronic messages, such as e-mail messages, with the computing platforms 130.

The messaging client 150 in the computing platform 110 can include a configuration for tracking a thread of messages 160 in which multiple messages are logically related to one another from an origin message designating one or more addresses including a sender and a recipient, to an immediate predecessor message designating one or more addressees including a sender and a recipient. An addressee master list 180 can be coupled to the messaging client 150 and can include all of the addressees designated for all messages in the message thread 160. Finally, message reply logic 170 can be coupled to the messaging client 150.

The message reply logic 170 can include program code enabled to render and control a distribution list management interface 200. The distribution list management interface 200 can be configured to provide a listing of the addressees in the addressee master list 180. The distribution list management interface 200 further can be configured to permit a selection of individual ones of the addressees in the distribution list to receive a reply message 190 to a message in the thread of messages 160. Optionally, the distribution list management interface 200 can be configured to permit the manual specification of addressees not included in the addressee master list 180. As yet another option, the distribution list management interface 200 can be configured to permit a selection of addressees in the distribution list to receive an attachment to the reply message 190.

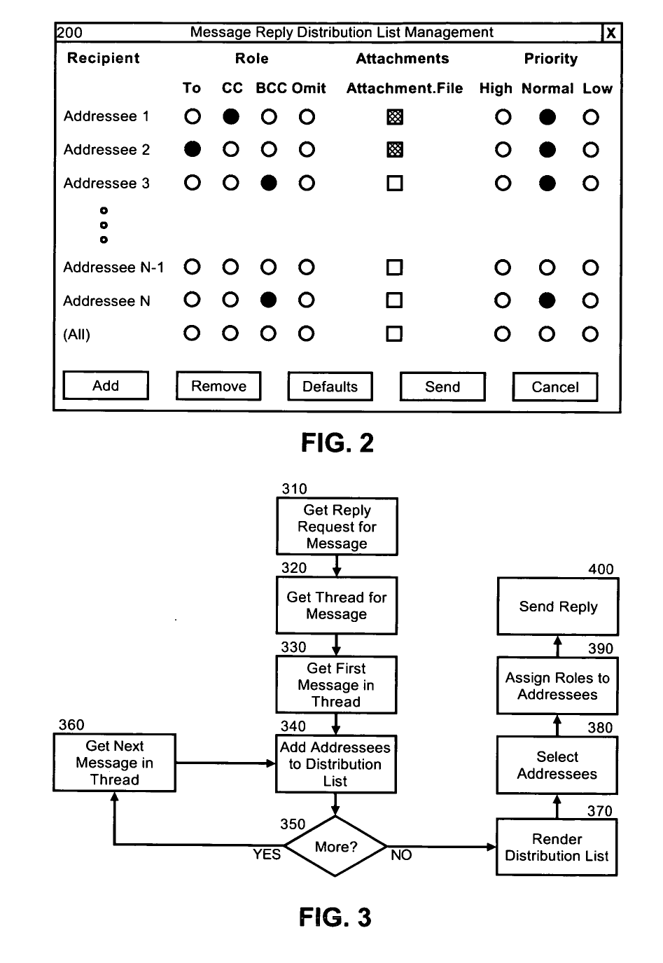

In further illustration, FIG. 2 is a screen shot of a graphical user interface (GUI) 200 configured for distribution list management for a reply message. The GUI 200 can include a listing of one or more addressees previously included in a message in a message thread for the reply message. A message recipient role can be assigned to selected ones of the addressees, including a “To” role, a “CC” role, a “BCC” role and an “OMIT” role. Optionally, different addressees can by default be assigned to particular message recipient roles. Of course, the default assignment of message recipient roles to addressees can be modified at any time. Individual ones of the addressees also can be selected to receive one or more attachments to the reply message. Finally, a priority can be assigned to the reply message on an addressee by addressee basis. Optionally, addressees not included in a message in the message thread can be added to the GUI 200 and existing addressees can be removed from the GUI 200.

Utilizing the GUI 200, a distribution list for a reply message can be established with ease while requiring a minimum of user interaction in managing the distribution list. In illustration, FIG. 3 is a flow chart illustrating a process for distribution list management for a reply message. Beginning in block 310, a request can be received to reply to a message in a message thread. In block 320, the message thread for the request can be retrieved and in block 330, a first message in the message thread can be selected for processing. Specifically, in block 340, the addressees for the first message in the message thread can be added to the distribution list for the reply message. The process can repeat in decision block 350 through block 340 for each other message in the message thread.

When no more messages in the message thread remain to be processed, in block 370 the distribution list can be rendered in a GUI for the reply message. In block 380, individual addressees in the distribution list can be selected to receive the reply message. In this regard, in block 390, different roles can be assigned to each selected recipient, including a “TO” role, a “CC” role, a “BCC” role and an “OMIT” role. Optionally, individual ones of the selected addressees can be further selected to receive one or more attachments to the reply message. Finally, in block 400 the reply can be sent to those selected addressees in the distribution list.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A distribution list management method for a reply message in a message thread, the method comprising:
identifying a set of addressees from among multiple messages in a message thread;
adding the set of addresses to a distribution list for a reply message to one of the multiple messages in the message thread;
selecting individual ones of the addressees in the distribution list to receive the reply message; and,
sending the reply message to the selected individual ones of the addressees.

2. The method of claim 1, wherein identifying a set of addressees from among multiple messages in a message thread, comprises identifying all addressees for all messages in a message thread.

3. The method of claim 1, wherein selecting individual ones of the addressees in the distribution list to receive the reply message, comprises:
rendering a graphical user interface (GUI) displaying the distribution list; and,
assigning at least one message recipient role to at least one of the addressees in the distribution list in the GUI.

4. The method of claim 3, further comprising further assigning an attachment for transmission to at least one of the addressees in the distribution list in the GUI.

5. The method of claim 3, further comprising adding at least one additional addressee to the distribution list not originally displayed in the GUI.

6. The method of claim 3, further comprising removing at least one addressee from the distribution as displayed in the GUI.

7. The method of claim 3, further comprising assigning a priority for the reply message to at least one of the addressees in the distribution list in the GUI.

8. A data processing system for distribution list management for a reply message, the system comprising:
a messaging client configured to process a message thread of multiple related messages, each of the messages comprising at least one addressee;
an addressee master list configured to store a distribution list of addressees for all of the multiple related messages in the message thread; and,
message reply logic comprising program code enabled to render a distribution list management user interface through which individual addressees in the addressee master list are selected to receive a reply message to a message in the message thread.

9. The system of claim 8, wherein the multiple related messages are electronic mail messages.

10. The system of claim 8, wherein the program code for the message reply logic is further enabled to assign a message recipient role to selected ones of the addressees in the addressee master list.

11. The system of claim 8, wherein the program code for the message reply logic is further enabled to assign at least one attachment for the reply message to selected ones of the addressees in the addressee master list.

12. The system of claim 8, wherein the program code for the message reply logic is further enabled to assign a priority for the reply message to selected ones of the addressees in the addressee master list.

13. The system of claim 10, wherein the message reply logic is further enabled to assign a default message recipient role to selected ones of the addressees in the addressee master list.

14. A computer program product comprising a computer usable medium having computer usable program code for distribution list management method for a reply message in a message thread, said computer program product including:
computer usable program code for identifying a set of addressees from among multiple messages in a message thread;
computer usable program code for adding the set of addresses to a distribution list for a reply message to one of the multiple messages in the message thread;
computer usable program code for selecting individual ones of the addressees in the distribution list to receive the reply message; and,
computer usable program code for sending the reply message to the selected individual ones of the addressees.

15. The computer program product of claim 13, wherein the computer usable program code for identifying a set of addressees from among multiple messages in a message thread, comprises computer usable program code for identifying all addressees for all messages in a message thread.

16. The computer program product of claim 13, wherein the computer usable program code for selecting individual ones of the addressees in the distribution list to receive the reply message, comprises:
computer usable program code for rendering a graphical user interface (GUI) displaying the distribution list; and,
computer usable program code for assigning at least one message recipient role to at least one of the addressees in the distribution list in the GUI.

17. The computer program product of claim 15, further comprising computer usable program code for further assigning an attachment for transmission to at least one of the addressees in the distribution list in the GUI.

18. The computer program product of claim 15, further comprising computer usable program code for adding at least one additional addressee to the distribution list not originally displayed in the GUI.

19. The computer program product of claim 15, further comprising computer usable program code for removing at least one addressee from the distribution as displayed in the GUI.

20. The computer program product of claim 15, further comprising computer usable program code for assigning a priority for the reply message to at least one of the addressees in the distribution list in the GUI.
